(19) United States
(12) Patent Application Publication
(10) Pub. No.: US 2026/0147645 A1
(43) Pub. Date: May 28, 2026

(54) SPLITTING MONOLITHIC WITH LAYERED ARCHITECTURE INTO MICROSERVICES

(71) Applicant: SAP SE, Walldorf (DE)

(72) Inventor: Hui Li, Shanghai (CN)

(21) Appl. No.: 18/960,273

(22) Filed: Nov. 26, 2024

(51) Int. Cl. G06F 9/54; G06F 9/50

(52) U.S. Cl. CPC G06F 9/545; G06F 9/5077

(57) ABSTRACT

Many monolithic applications use a layered architecture that comprises a large number of components. The large number of components may be divided into a smaller number of layers. In a microservices application, independent small services provide specific functions. The small services communicate with each other using remote call protocols. To convert a monolithic application to a microservices architecture, the components of one layer are divided into multiple groups according to the criteria of minimizing the communication of remote calls among the different groups. The components of other layers are assigned to the groups according to the criteria of minimizing the communication of remote calls among the different groups. A user interface allows the user to adjust the assignment of components to groups. Once the assignment of components to groups is complete, the monolithic application is converted to a microservices architecture according to the assignments.

### RELATED APPLICATIONS

This application is related to SAP reference no. 240134US01 (SLW Dkt No. 2058.H11US1), entitled: “SPLITTING APPLICATION INTO MICROSERVICES USING LARGE LANGUAGE MODEL,” the disclosure of which is hereby incorporated by reference in its entirety.

### TECHNICAL FIELD

The subject matter disclosed herein generally relates to systems for converting monolithic applications with layered architecture into microservices.

### BACKGROUND

Existing applications may be monolithic and use a layered architecture internally. Many cloud systems use microservices, which are composed of many independent small services. The small services often communicate with each other using application programming interfaces (APIs) and communication protocols such as hypertext transport protocol (HTTP) or Google Remote Procedure Calls (gRPC).

### BRIEF DESCRIPTION OF THE DRAWINGS

FIG. 1 shows a network diagram illustrating an example network environment suitable for providing monolithic applications or microservice-based applications and for splitting monolithic applications with layered architectures into microservices.

FIG. 2 shows a block diagram of an application server, suitable for splitting monolithic applications with layered architectures into microservices.

FIG. 3 is a block diagram of an example monolithic application with a layered architecture.

FIG. 4 shows an example grouping of business layer components of the example monolithic application of FIG. 3.

FIG. 5 shows an illustration of an example user interface for grouping components of a monolithic application.

FIG. 6 shows a flowchart illustrating a method of splitting monolithic applications with layered architectures into microservices.

FIG. 7 shows a flowchart illustrating a method of splitting monolithic applications with layered architectures into microservices.

FIG. 8 shows a block diagram showing one example of a software architecture for a computing device.

FIG. 9 shows a block diagram of a machine in the example form of a computer system within which instructions may be executed for causing the machine to perform any one or more of the methodologies discussed herein.

### DETAILED DESCRIPTION

Example methods and systems are directed to splitting monolithic applications with layered architectures into microservices. Many monolithic applications use a layered architecture that comprises a large number of components (e.g., dozens or hundreds of components). The components may be classes, libraries, modules, source code files, or other discrete subdivisions of an application.

The large number of components may be divided into a smaller number of layers (e.g., three, four, or five layers). For example, the Model-View-Controller (MVC) design pattern uses a database layer, a model layer that accesses data from the database layer and performs operations on the accessed data, a controller layer that provides functionality to interact with the model layer, and a view layer that provides a user interface to interact with the controller layer. As another example, the Presentation-Business-Persistence (PBP) design pattern uses a database layer, a persistence layer, a business layer, and a presentation layer. The persistence layer accesses data from the database layer and makes the data accessible in an object-oriented form to the other layers. The business layer uses and manipulates data from the persistence layer. The presentation layer provides a user interface to interact with the business layer.

In a microservices application, independent small services provide specific functions. The small services communicate with each other using remote call protocols such as hypertext transport protocol (HTTP) or Google remote procedure call (gRPC). Existing monolithic applications may be converted to microservice architecture by engineers who estimate the most efficient grouping of components into services. However, the estimation lacks quantitative analysis, which may be quite different from the real situation. If the monolithic application is not split properly, different microservices will produce huge numbers of remote calls among them, which is unexpected and results in poor performance.

As discussed herein, systems and methods for quantitatively determining the division of components into microservices are provided. In many monolithic applications, the business layer is the most complex layer. Accordingly, the components of the business layer are divided into multiple groups according to the criteria of minimizing the communication of remote calls among the different groups. After the groups are formed, the components of the business layer are assigned to the groups according to the criteria of minimizing the communication of remote calls among the different groups. Thereafter, components of the remaining layers are assigned to the groups according to the same criteria.

Once the groups are created and the assignment of components to groups is complete, a user interface may be presented to a user. The user interface allows the user to adjust the assignment of components to groups, add new groups, delete groups, or any suitable combination thereof. Once the assignment of components to groups is complete, the monolithic application is converted to a microservices architecture according to the assignments.

By use of the described systems and methods, the efficient conversion of monolithic applications with layered architecture to a microservice architecture is facilitated. By comparison with systems that do not use quantitative analysis, the efficiency of the resulting microservices application is improved. The improved efficiency derives from reduced communications between the resulting microservices, which saves computing resources such as processor cycles and network bandwidth.

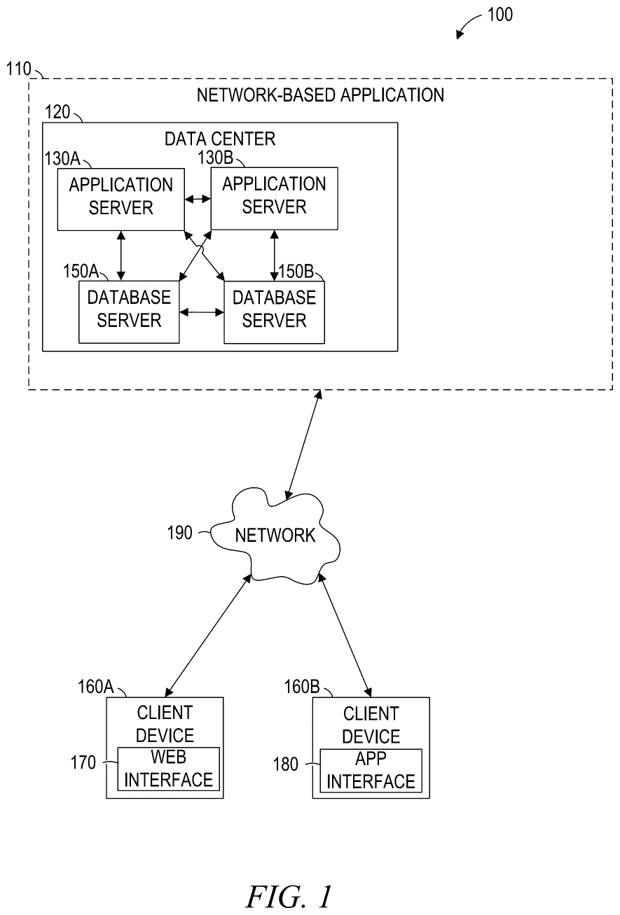

FIG. 1 shows a network diagram illustrating an example network environment 100 suitable for providing monolithic applications or microservice-based applications and for splitting monolithic applications with layered architectures into microservices. The network environment 100 includes a network-based application 110, client devices 160A and 160B, and a network 190. The network-based application 110 is implemented at a data center 120 comprising application servers 130A and 130B in communication with database servers 150A and 150B. An application executing on the application servers 130A-130B may access data from the database servers 150A-150B. The letter suffixes of reference numbers may be omitted when doing so does not raise ambiguity. For example, the application servers 130A-130B may be referred to collectively as “application servers 130.” Similarly, when the specific one of the application servers 130A-130B is not of particular import, “application server 130” may be referenced.

The application running on the application server 130 may provide services to the client devices 160A and 160B. For example, a user of the client device 160A may be an employee of a business using a business application. The user may use the services to generate invoices, manage employees, develop other applications, or any suitable combination thereof. Use of the application may entail filtering data (e.g., to review certain invoices, employees, applications, or the like). The user interface for the application may be presented using a web interface 170 or an app interface 180.

The network-based application 110 may be implemented as a monolithic application using a layered architecture or by using a collection of microservices. One or more of the application servers 130 may act as a registration server. Microservices register themselves with the registration server. Once a microservice is registered, it can be discovered by requests to the registration server. For example, a user of the client device 160A may request information about a microservice by providing the name of the microservice or a description of the microservice to the registration server. In response, the registration server provides information about one or more registered microservices. The user may use the provided information to configure the network-based application 110 to make use of one or more of the microservices.

The application servers 130 may communicate with the database servers 150 using a representational state transfer (REST) API, the Open Data Protocol (ODATA), or another API. The data may be described in metadata that provides contextual information related to the data. Metadata includes column names, data types and data relationships. If the values are from a fixed dataset, the dataset may be loaded and the loaded information used as a table description.

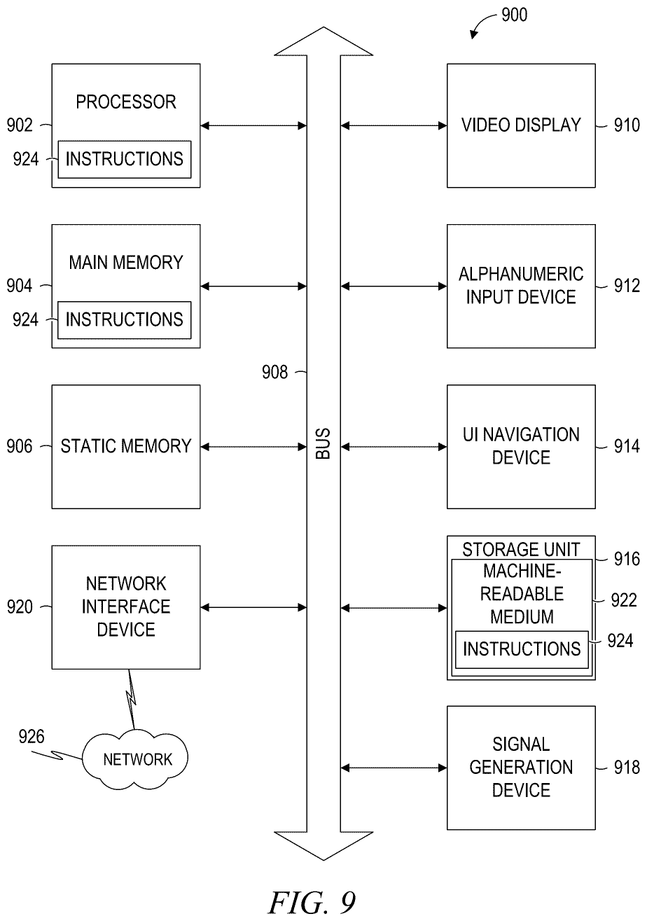

The application servers 130A-130B, the database servers 150A-150B, and the client devices 160A-160B may each be implemented in a computer system, in whole or in part, as described below with respect to FIG. 9. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database, a disk-based database, a remote database, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130B, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., two application servers 130A-130B, two client devices 160A and 160B, and the like), any number of each element is contemplated. For example, the application server 130A may be one of dozens or hundreds of active and standby servers and provide services to millions of client devices.

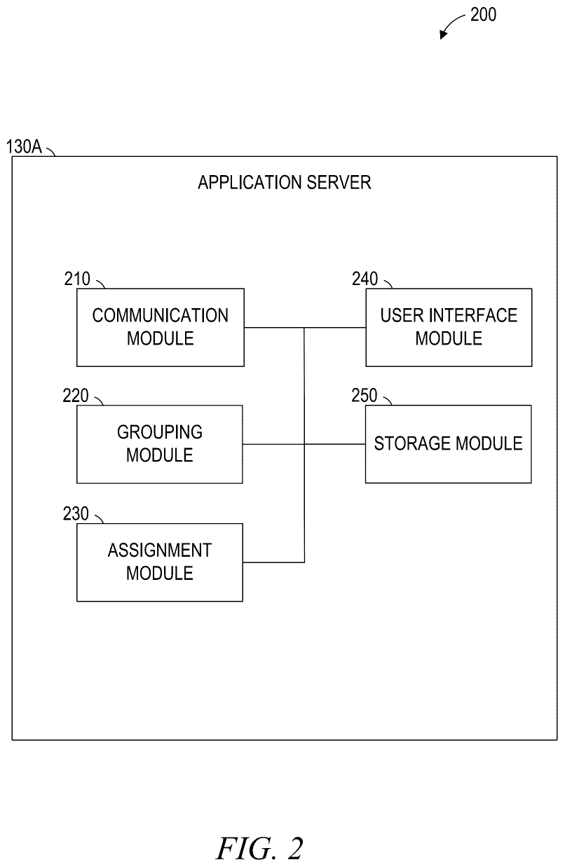

FIG. 2 shows a block diagram 200 of the application server 130A, suitable for splitting monolithic applications with layered architectures into microservices. The application server 130A is shown as including a communication module 210, a grouping module 220, an assignment module 230, a user interface module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130A and transmits data from the application server 130A. For example, the communication module 210 may send a user interface (e.g., hypertext markup language [HTML] for rendering in a web browser) from the user interface module 240 to the client device 160A. The communication module 210 may receive, from the client device 160A and via the user interface, a request to recommend groups of components of a monolithic application for implementation as microservices.

The grouping module 220 groups components of one layer of a monolithic application. For example, inter-group communications of the components may be minimized to determine the groups. The assignment module 230 assigns components of another layer of the monolithic application to the groups determined by the grouping module 220.

Data, metadata, documents, instructions, or any suitable combination thereof may be stored and accessed by the storage module 250. For example, local storage of the application server 130A, such as a hard drive, may be used. As another example, network storage may be accessed by the storage module 250 via the network 190.

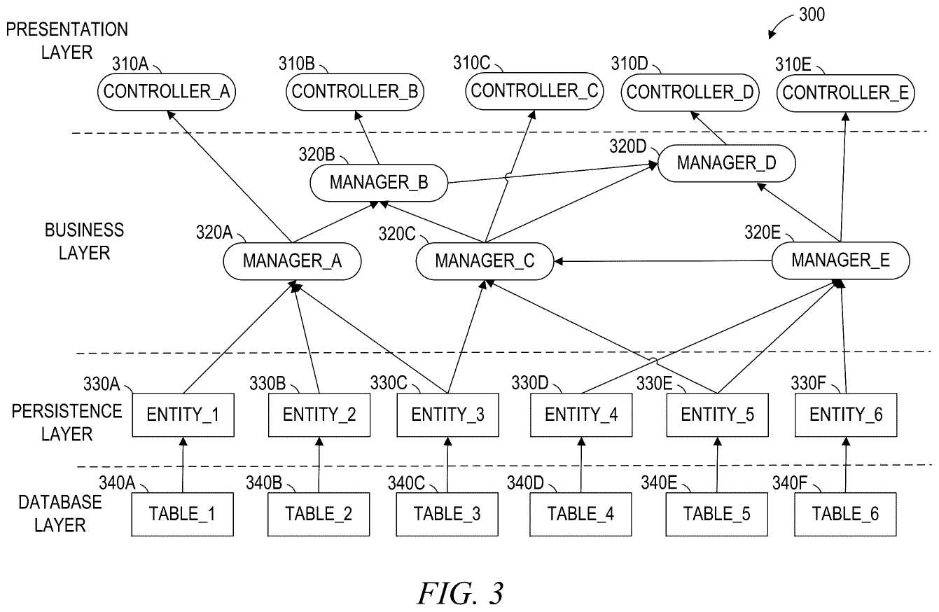

FIG. 3 is a block diagram 300 of an example monolithic application with a layered architecture. Various layered architectures may be used. In the example of FIG. 3, the monolithic application is divided into four layers: a presentation layer, a business layer, a persistence layer, and a database layer. The presentation layer includes controllers 310A, 310B, 310C, 310D, and 310E. The business layer includes managers 320A, 320B, 320C, 320D, and 320E. Each of the managers 320A-320E communicates with one of the controllers 310A-310E. The persistence layer includes entities 330A, 330B, 330C, 330D, 330E, and 330F. The database layer includes tables 340A, 340B, 340C, 340D, 340E, and 340F. Each of the entities 330A-330F accesses data from one of the tables 340A-340F.

The managers 320A-320E access data from the entities 330A-330F of the persistence layer, other ones of the managers 320A-320E, or any suitable combination thereof. For example, the manager 320A accesses data from the entities 330A-330C. As another example, the manager 320B does not access data from any of the entities 330A-330F, but accesses data from the managers 320A and 320C. As still another example, the manager 320C accesses data from the entities 330C and 330E, as well as from the manager 320E.

Every entity of the persistence layer is mapped to one table of the database layer. The entities 330A-330F contain the create, read, update, and delete (CRUD) interfaces to access and modify the corresponding one of the tables 340A-340F in the database layer.

The controllers 310A-310E of the presentation layer is mapped to one of the managers 320A-320E of the business layer. The controllers 310A-310E access data and modify data from the corresponding one of the managers 320A-320E to provide a user interface to the monolithic application.

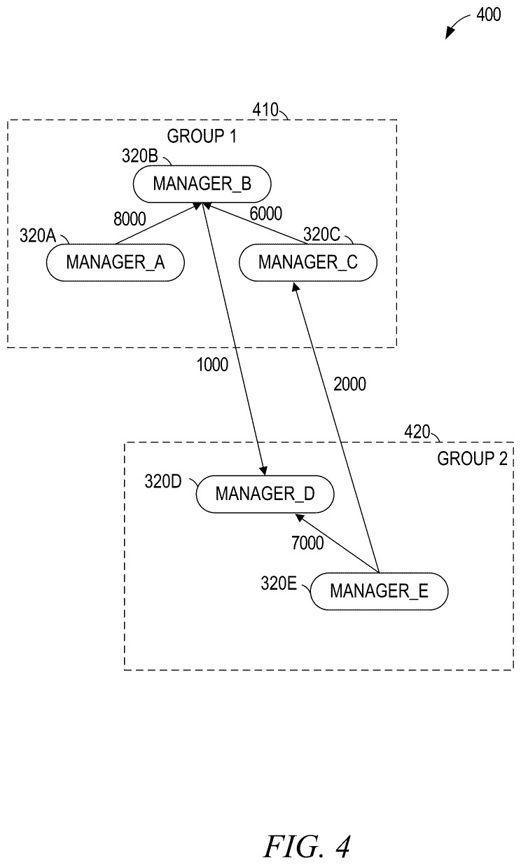

FIG. 4 shows an example grouping 400 of the business layer components of the example monolithic application of FIG. 3. In the example of FIG. 4, two groups 410 and 420 are formed. Each of the managers 320A-320E is assigned to one of the two groups 410-420. The groups 410 and 420 may be used as the basis for a microservices architecture, wherein all of the components of the group 410 are placed in one microservice and all of the components of the group 420 are placed in another microservice. Two groups are used by way of example, but more groups may be used in practice (e.g., at least six groups or at least ten groups).

The grouping module 220 of FIG. 2 may assign the managers 320A-320E to the groups 410-420 based on a number of communications between each pair of the managers 320A-320E. The arrows connecting the components in FIG. 4 are labeled with a number of communications between the linked components. For example, the manager 320A has 8,000 communications with the manager 320B and no communications with any other manager.

The grouping module 220 may be configured to create a predetermined number of groups with the constraints that no group can be empty and to minimize the number of communications between groups. In the example of FIG. 4, it can be seen that these constraints are met. Using the groups shown in FIG. 4, there are 3,000 communications between the group 410 and the group 420. The manager 320B has more than 3,000 communications with the manager 320A and the manager 320C, therefore placing the manager 320B in a different group from either the manager 320A or the manager 320C would increase the inter-group communications. The manager 320D and the manager 320E have 7,000 communications, so again, placing the manager 320D and the manager 320E in different groups would increase the inter-group communications. Accordingly, for a two-microservice solution, the allocation of managers 320A-320E to groups minimizes the inter-microservice communications.

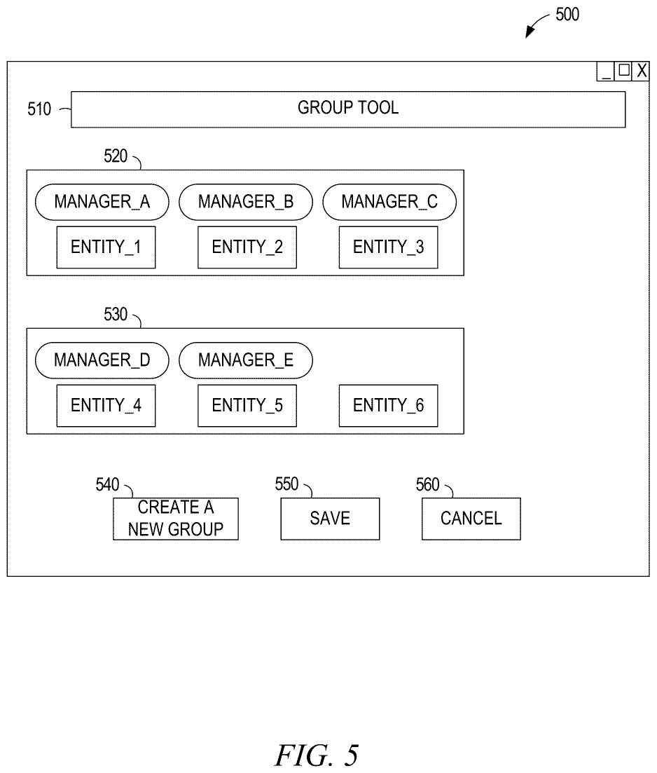

FIG. 5 shows an illustration of an example user interface 500 for grouping components of a monolithic application. The user interface 500 may be generated by the application server 130A and presented on a display device of the client device 160A or 160B, all of FIG. 1. The user interface 500 may be presented to allow a user to modify the assignment of components to groups. The user interface 500 includes a title 510, a first group area 520, a second group area 530, and buttons 540, 550, and 560. The group areas 520 and 530 include icons that represent the managers 320A-320E and the entities 330A-330F of FIG. 3.

The title 510 indicates that the user interface 500 is for a group tool. The first group area 520 shows that the managers 320A-320C and the entities 330A-330C have been assigned to a first group. The second group area 530 shows that the managers 320D and 320E and the entities 330D-330F have been assigned to a second group.

The managers 320A-320E and the entities 330A-330F may be represented by icons. The icons may be dragged and dropped by a user from one group to another. For example, the user may drag the icon for the manager 320D from the second group area 530 to the first group area 520 and drop the icon there. In response, the application server 130A reassigns the manager 320D from the second group to the first group.

The application server 130A creates a new group in response to detecting a user operation of the button 540. The user may assign components to the new group by dragging the icon for each desired component from an existing group to a group area for the new group. Alternatively, operation of the button 540 may cause the application server 130A to perform the group assignment process again, this time with one additional group. The user interface 500 is then refreshed with the component assignment data for the new number of groups.

The button 550 is operable to save the changes in assignments of components to groups. The button 560 is operable to cancel the changes in assignments of components to groups. Thus, by use of the user interface 500, the user is enabled to control the assignments of components to groups.

In some example embodiments, additional data is displayed in the user interface 500. For example, the number of communications between groups or between components may be displayed. The displayed values may be updated in response to changes in assignments made by the user. For example, if the manager 320A is moved from the first group to the second group, the user interface 500 may show an increase in the number of inter-group communications, providing useful information to the user regarding the change being considered.

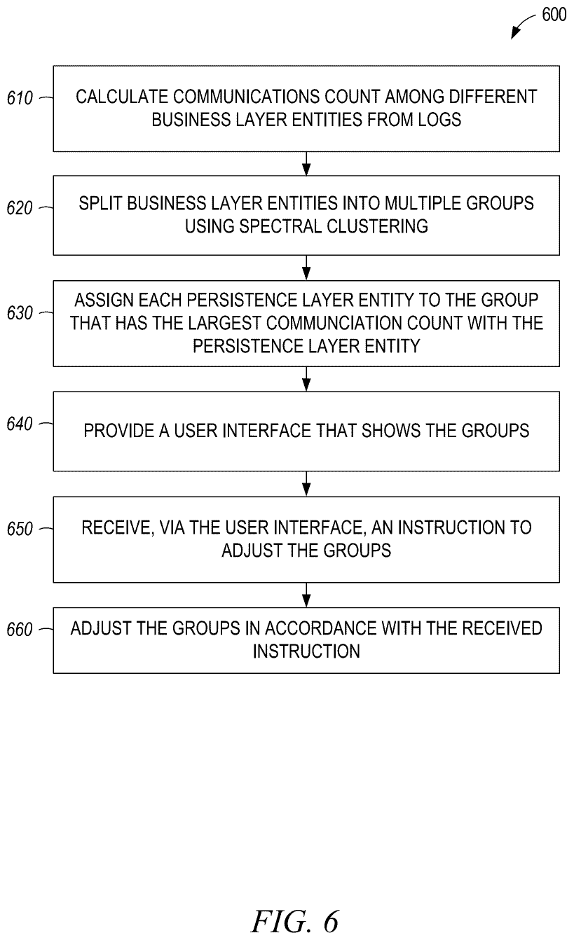

FIG. 6 shows a flowchart illustrating a method 600 of splitting monolithic applications with layered architectures into microservices. The method 600 includes operations 610, 620, 630, 640, 650, and 660. By way of example and not limitation, the method 600 is described as being performed by the application server 130A of FIG. 1, using the modules of FIG. 2, the groups of FIG. 4, and the user interface of FIG. 5.

In operation 610, the grouping module 220 calculates a communications count among different business layer entities from logs. For example, a monolithic application may generate one or more log files. The log files may indicate communications between business layer entities. For example, a line of a log file may indicate a name of the entity making a call and a name of the entity being called. The log file may be filtered using regular expressions and a number of lines for each calling/called entity pair counted. From the calculated data, a matrix may be formed. For example, each row may contain data for a calling entity and each column may contain data for a called entity. Values of cells along the diagonal in which the calling and called entities are the same may be set to zero. As another example, the direction of the communication may be ignored, in which case the values of the matrix will be symmetric about the main diagonal.

The grouping module 220, in operation 620, splits the business layer entities into multiple groups using spectral clustering. Spectral clustering may comprise the following steps.

(1). Create the graph Laplacian from the communication count matrix. The Laplacian matrix captures the structure of the data and is used for spectral clustering. To illustrate, consider the communication count matrix, C, below, for six business managers.

$$C = [ \begin{matrix}0 & 6900 & 4800 & 3500 & 2200 & 4100 \\ 6900 & 0 & 45600 & 2700 & 330 & 875 \\ 4800 & 45600 & 0 & 1750 & 3450 & 1420 \\ 3500 & 2700 & 1750 & 0 & 8860 & 5770 \\ 2200 & 330 & 3450 & 8860 & 0 & 9300 \\ 4100 & 875 & 1420 & 5770 & 9300 & 0\end{matrix} ]$$

From the communication count matrix, the degree matrix is computed. The degree matrix, D, is formed by adding all of the values in a column and placing the sum for the column along the diagonal, zeroing out all other cells. Thus, the sum of cells in the first column is placed in the first cell of the first column, the sum of cells in the second column is placed in the second cell of the second column, and so on.

$$D = [ \begin{matrix}21500 & 0 & 0 & 0 & 0 & 0 \\ 0 & 56405 & 0 & 0 & 0 & 0 \\ 0 & 0 & 57020 & 0 & 0 & 0 \\ 0 & 0 & 0 & 22580 & 0 & 0 \\ 0 & 0 & 0 & 0 & 24140 & 0 \\ 0 & 0 & 0 & 0 & 0 & 21465\end{matrix} ]$$

The Laplacian matrix is computed from the degree matrix and the communication count matrix, L=D−C.

$$L = [ \begin{matrix}21500 & - 6900 & - 4800 & - 3500 & - 2200 & - 4100 \\ - 6900 & 56405 & - 45600 & - 2700 & - 330 & - 875 \\ - 4800 & - 45600 & 57020 & - 1750 & - 3450 & - 1420 \\ - 3500 & - 2700 & - 1750 & 22580 & - 8860 & - 5770 \\ - 2200 & - 330 & - 3450 & - 8860 & 24140 & - 9300 \\ - 4100 & - 875 & - 1420 & - 5770 & - 9300 & 21465\end{matrix} ]$$

(2). Compute the eigenvectors of the Laplacian matrix. These eigenvectors correspond to the smallest eigenvalues and capture the underlying structure of the data. The number of eigenvectors to be computed depends on the desired number K of clusters. The eigenvalues for L are [0, 12732.7, 25973.9, 28147.1, 33841.5, 102414.9]. The corresponding eigenvectors for L are:

$$Eigenvectors = [ \begin{matrix}0.40824829 & 0.21186259 & 0.81875223 & - 0.29732024 & - 0.17130996 & 0.01859933 \\ 0.40824829 & 0.49962217 & - 0.25671251 & 0.13007865 & 0.06155766 & - 0.70505312 \\ 0.40824829 & 0.47766361 & - 0.28150221 & 0.15348247 & 0.02874159 & 0.70819797 \\ 0.40824829 & - 0.33445071 & - 0.2775852 & - 0.6837427 & 0.42047232 & 0.01102078 \\ 0.40824829 & - 0.41690655 & - 0.23325415 & 0.06558588 & - 0.7745545 & - 0.02964071 \\ 0.40824829 & - 0.4377911 & 0.23030184 & 0.63191594 & 0.43509289 & - 0.00312426\end{matrix} ]$$

(3). Form the affinity matrix by the eigenvectors of the K smallest eigenvalues. Each row of the affinity matrix corresponds to a data point, and each column corresponds to an eigenvector. This matrix represents the low-dimensional representation of the data.

Since the entities are treated atomically, K is equal to or less than the number of entities. An affinity matrix, V, is formed by the K eigenvectors with the K smallest eigenvalues of the Lapacian matrix. For this example, K=2. The two smallest eigenvalues for L are 0 and 12732.7, which correspond to the first two eigenvectors. Thus, V is:

$$V = [ \begin{matrix}0.40824829 & 0.21186259 \\ 0.40824829 & 0.49962217 \\ 0.40824829 & 0.47766361 \\ 0.40824829 & - 0.33445071 \\ 0.40824829 & - 0.41690655 \\ 0.40824829 & - 0.4377911\end{matrix} ]$$

The element (V_{i,o}, V_{i,1}) represents the compressed representation of the i-th data point in 2-dimensional space. That is to say, in the 2-dimensional space, MANAGER_A is at position (0.40824829, 0.21186259), MANAGER_B is at position (0.40824829, 0.49962217), MANAGER_C is at position (0.40824829, 0.47766361), MANAGER_D is at position (0.40824829,−0.33445071), MANAGER_E is at position (0.40824829,−0.41690655), and MANAGER_F is at position (0.40824829,−0.4377911).

(4). A clustering algorithm such as k-means is applied to the affinity matrix to group similar data points. The number of clusters is typically determined beforehand or can be estimated using techniques like the eigengap heuristic.

In this example, each business layer component is at the two-dimensional location of the corresponding row of V. k-means clustering is used to determine the two clusters of most-similarly related elements. In this example, the first three rows are in one group and the last three rows are in another group.

In the method 600, operations 610 and 620 are performed to split business layer entities in multiple groups. In other example embodiments, the entities being used to define the groups are components of a monolithic application identified in a different way. For example, components may be ordered based on total communications and a predetermined number of the components with the most communications selected. The selected components may be used as a first portion of the application to define the groups based on the communications among the selected components.

In operation 630, the assignment module 230 assigns each persistence layer entity to the group that has the largest communication count with the persistence layer entity. One principle of microservices is Database per Service (one service has its database). So, one database table (and its mapping entity) should only be owned by one microservice. After the business layer entities have been divided into K groups, each persistence layer entity is placed into the group with which it communicates the largest number of times. The number of communications between a persistence layer entity and the business layer entities may be determined by analyzing logs. The number of communications between a persistence layer entity and a group of business layer entities is the sum of the number of communications between the persistence layer entity and each of the business layer entities in the group.

In the method 600, operation 630 is performed to add persistent layer entities to the groups defined in operation 620. In other example embodiments, the entities being added to the groups are components of a monolithic application identified in a different way. For example, a second predetermined number of the components with the most communications, excluding the components of the first portion, may be selected. The selected second predetermined number of components may be used as a second portion of the components of the application to be added to the groups based on the communications among the components of the first and second portions.

Operation 630 may be repeated for additional layers (or portions) of the monolithic application. For example, database layer entities may be added to the groups based on their communications with the entities already assigned to the groups, followed by presentation layer entities on the same basis.

The user interface module 240, in operation 640, provides a user interface that shows the groups. For example, the user interface 500 of FIG. 5 may be provided, showing the business layer entities and persistence layer entities that have been assigned to the automatically created groups.

In operation 650, the user interface module 240 receives, via the user interface, an instruction to adjust the groups. For example, the instruction may be to move a business layer entity from one group to another group, to create a group, or to delete a group.

The assignment module 230 adjusts the groups in accordance with the received instruction (operation 660). For example, the assignment module 230 may move a business layer entity from one group to another group, in accordance with the instruction.

Thus, by the use of the method 600, the application server 130A aids in converting a monolithic application with a layered architecture to a microservices architecture. In operations 610-630, default groupings of components of the monolithic application are intelligently created and proposed. In operations 640-660, a user interacts with a user interface to modify the proposed groupings and apply human intelligence to further improve the microservices design.

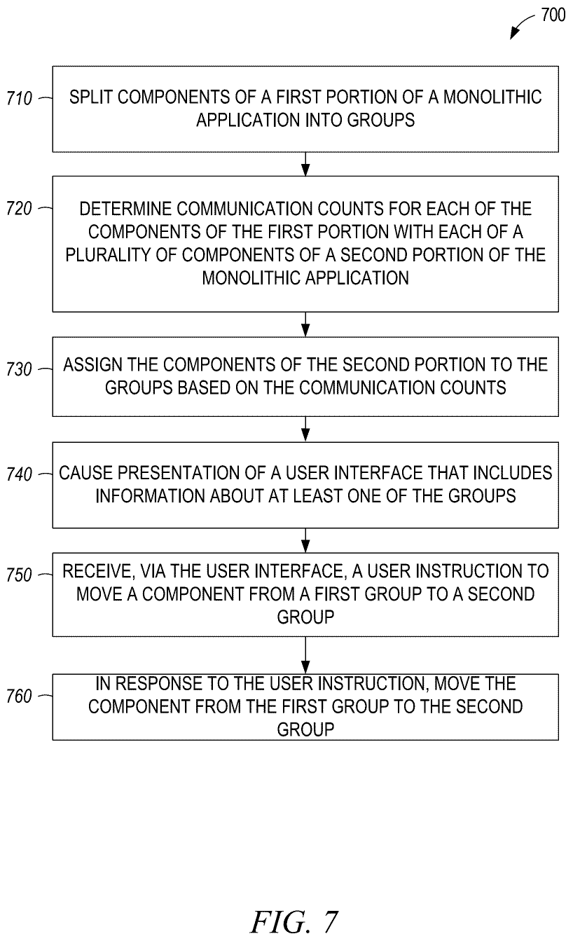

FIG. 7 shows a flowchart illustrating a method 700 of splitting monolithic applications with layered architectures into microservices. The method 700 includes operations 710, 720, 730, 740, 750, and 760. By way of example and not limitation, the method 700 is described as being performed by the application server 130A of FIG. 1, using the modules of FIG. 2, the groups of FIG. 4, and the user interface of FIG. 5.

In operation 710, the grouping module 220 splits components of a first portion of a monolithic application into groups. The components of the first portion may be components of a particular layer (e.g., the business layer) of the monolithic application. Alternatively, the monolithic application may execute using multiple processing or memory resources (e.g., comprise a CPU portion and a GPU portion). Accordingly, the components of the first portion may be the components that use a particular hardware resource.

The splitting of the components of the first portion into the groups may be based on a communication count between each pair of the components of the first portion. For example, the communications within groups may be maximized, the communications among groups may be minimized, or both. The communications within a group may be referred to as the internal communications of the group. The communications between a group and other groups may be referred to as the external communications of the group.

The assignment module 230, in operation 720, determines communication counts for each of the components of the first portion with each of a plurality of components of a second portion of the monolithic application. The components of the second portion may be components of a different layer (e.g., the persistence layer) of the monolithic application. Alternatively, the components of the second portion may be the components of the monolithic application that use a different hardware resource than the components of the first portion.

In operation 730, the assignment module 230 assigns the components of the second portion to the groups based on the communication counts. For example, the components of the second portions may be assigned to the groups in a manner that maximizes intra-group communications, minimizes inter-group communications, or any suitable combination thereof.

The user interface module 240, in operation 740, causes presentation of a user interface that includes information about at least one of the groups. For example, the user interface 500 of FIG. 5 may be presented.

The assignment module 230 receives, via the user interface, a user instruction to move a component from a first group to a second group (operation 750). The user instruction may be received in response to the user dragging an icon that represents the component from an area that represents the first group to an area that represents the second group.

In operation 760, in response to the user instruction, the assignment module 230 moves the component from the first group to the second group. Operations 740-760 may be repeated any number of times, updating the user interface as the user moves components among the groups. When the modifications are complete, the user may use the grouping information to guide conversion of the monolithic application to a microservices application. Alternatively, a large language model (LLM) may be provided the source code for the components of the monolithic application and instructions to convert the monolithic application to a microservices application by generating a microservice for each of the identified groups.

In view of the above-described implementations of subject matter this application discloses the following list of examples, wherein one feature of an example in isolation or more than one feature of an example, taken in combination and, optionally, in combination with one or more features of one or more further examples are also examples falling within the disclosure of this application.

Example 1 is a system comprising: a memory that stores instructions; and one or more processors coupled to the memory and configured to execute the instructions to perform operations comprising: splitting components of a first portion of a monolithic application into groups; determining communication counts for each of the components of the first portion with each of a plurality of components of a second portion of the monolithic application; assigning the components of the second portion to the groups based on the communication counts; causing presentation of a user interface that includes, information about at least one of the groups; receiving, via the user interface, a user instruction to move a component from a first group to a second group; and in response to the user instruction, moving the component from the first group to the second group.

In Example 2, the subject matter of Example 1, wherein: the monolithic application uses a layered architecture comprising a plurality of layers; and the first portion of the monolithic application corresponds to a layer of the plurality of layers.

In Example 3, the subject matter of Example 2, wherein the second portion of the monolithic application corresponds to a second layer of the plurality of layers.

In Example 4, the subject matter of Examples 1-3, wherein the splitting of the components of the first portion into the groups is based on a communication count between each pair of the components of the first portion.

In Example 5, the subject matter of Example 4, wherein the operations further comprise determining the communication counts between each of the pairs of the components of the first portion based on log files.

In Example 6, the subject matter of Example 5, wherein the splitting of the components of the first portion into the groups comprises: generating a communication count matrix that has width and height equal to a count of the components of the first portion, each cell of the communication count matrix located at an intersection of a column and a row, each cell having a value based on the count of communications between a first component assigned to the column of the cell and a second component assigned to the row of the cell; generating an affinity matrix based on the communication count matrix; and applying a clustering algorithm to the affinity matrix to split the components into a predetermined number of groups.

In Example 7, the subject matter of Example 6, wherein the generating of the affinity matrix comprises: determining a Laplacian matrix from the communication count matrix; determining eigenvectors of the Laplacian matrix; and generating the affinity matrix from the eigenvectors.

In Example 8, the subject matter of Examples 1-7, wherein the assigning of the components of the second portion to the groups based on the communication counts comprises maximizing a total internal communication count within the groups and minimizing a total external communication count among the groups.

In Example 9, the subject matter of Examples 1-8, wherein the receiving of the user instruction to move the component from the first group to the second group comprises detecting that a representation of the component has been dragged from a first area of the user interface that represents the first group to a second area of the user interface that represents the second group.

Example 10 is a non-transitory computer-readable medium that stores instructions that, when executed by one or more processors, cause the one or more processors to perform operations comprising: splitting components of a first portion of a monolithic application into groups; determining a communication count for each of the components of the first portion with each of a plurality of components of a second portion of the monolithic application; assigning the components of the second portion to the groups based on the communication counts; causing presentation of a user interface that includes, information about at least one of the groups; receiving, via the user interface, a user instruction to move a component from a first group to a second group; and in response to the user instruction, moving the component from the first group to the second group.

In Example 11, the subject matter of Example 10, wherein the splitting of the components of the first portion into the groups is based on a communication count between each pair of the components of the first portion.

In Example 12, the subject matter of Example 11, wherein the operations further comprise determining the communication counts between each of the pairs of the components of the first portion based on log files.

In Example 13, the subject matter of Examples 11-12, wherein the splitting of the components of the first portion into the groups comprises: generating a communication count matrix that has width and height equal to a count of the components of the first portion, each cell of the communication count matrix located at an intersection of a column and a row, each cell having a value based on the communication count between a first component assigned to the column of the cell and a second component assigned to the row of the cell; generating an affinity matrix based on the communication count matrix; and applying a clustering algorithm to the affinity matrix to split the components into a predetermined number of groups.

In Example 14, the subject matter of Example 13, wherein the generating of the affinity matrix comprises: determining a Laplacian matrix from the communication count matrix; determining eigenvectors of the Laplacian matrix; and generating the affinity matrix from the eigenvectors.

In Example 15, the subject matter of Examples 10-14, wherein the assigning of the components of the second portion to the groups based on the communication counts comprises maximizing a total internal communication count within the groups and minimizing a total external communication count among the groups.

In Example 16, the subject matter of Examples 10-15, wherein the receiving of the user instruction to move the component from the first group to the second group comprises detecting that a representation of the component has been dragged from a first area of the user interface that represents the first group to a second area of the user interface that represents the second group.

Example 17 is a method comprising: splitting, by one or more processors, components of a first portion of a monolithic application into groups; determining a communication count for each of the components of the first portion with each of a plurality of components of a second portion of the monolithic application; assigning the components of the second portion to the groups based on the communication counts; causing presentation of a user interface that includes, information about at least one of the groups; receiving, via the user interface, a user instruction to move a component from a first group to a second group; and in response to the user instruction, moving the component from the first group to the second group.

In Example 18, the subject matter of Example 17, wherein the splitting of the components of the first portion into the groups is based on a communication count between each pair of the components of the first portion.

In Example 19, the subject matter of Example 18 includes determining the communication counts between each of the pairs of the components of the first portion based on log files.

In Example 20, the subject matter of Example 19, wherein the splitting of the components of the first portion into the groups comprises: generating a communication count matrix that has width and height equal to a count of the components of the first portion, each cell of the communication count matrix located at an intersection of a column and a row, each cell having a value based on the communication count between a first component assigned to the column of the cell and a second component assigned to the row of the cell; generating an affinity matrix based on the communication count matrix; and applying a clustering algorithm to the affinity matrix to split the components into a predetermined number of groups.

Example 21 is an apparatus comprising means to implement any of Examples 1-20.

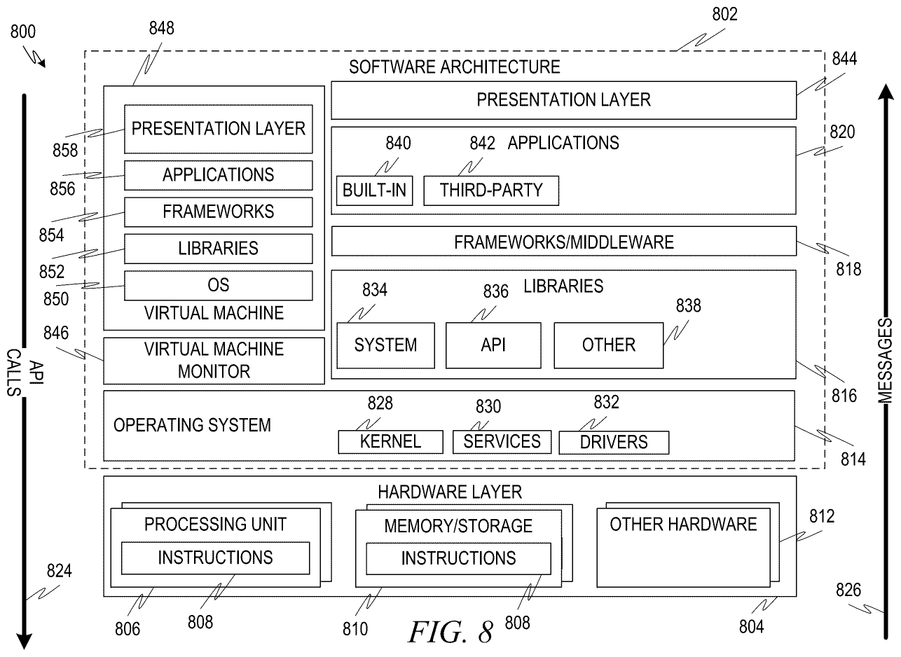

FIG. 8 shows a block diagram 800 showing one example of a software architecture 802 for a computing device. The software architecture 802 may be used in conjunction with various hardware architectures, for example, as described herein. FIG. 8 is merely a non-limiting example of a software architecture, and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 9.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812 which represents any other hardware of the hardware layer 804, such as the other hardware illustrated as part of the software architecture 802.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and presentation layer 844. Operationally, the applications 820 and/or other components within the layers may invoke application programming interface (API) calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the software architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 and/or other software components/modules. For example, the frameworks/middleware 818 may provide various graphic user interface (GUI) functions, high-level resource management, high-level location services, and so forth. The frameworks/middleware 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built-in operating system functions (e.g., kernel 828, services 830 and/or drivers 832), libraries (e.g., system libraries 834, API libraries 836, and other libraries 838), and frameworks/middleware 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine 848 as well as the interface with the host operating system (i.e., operating system 814). A software architecture executes within the virtual machine 848 such as an operating system 850, libraries 852, frameworks/middleware 854, applications 856 and/or presentation layer 858. These layers of software architecture executing within the virtual machine 848 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 9 shows a block diagram of a machine in the example form of a computer system 900 within which instructions 924 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube [CRT]). The computer system 900 also includes an alphanumeric input device 912 (e.g., a keyboard or a touch-sensitive display screen), a user interface (UI) navigation (or cursor control) device 914 (e.g., a mouse), a storage unit 916, a signal generation device 918 (e.g., a speaker), and a network interface device 920.

### Machine-Readable Medium

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting a machine-readable medium 922.

While the machine-readable medium 922 is shown in FIG. 9 to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with the instructions 924. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 924 may further be transmitted or received over a communications network 926 using a transmission medium. The instructions 924 may be transmitted using the network interface device 920 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors coupled to the memory and configured to execute the instructions to perform operations comprising:
splitting components of a first portion of a monolithic application into groups;
determining communication counts for each of the components of the first portion with each of a plurality of components of a second portion of the monolithic application;
assigning the components of the second portion to the groups based on the communication counts;
causing presentation of a user interface that includes information about at least one of the groups;
receiving, via the user interface, a user instruction to move a component from a first group to a second group; and
in response to the user instruction, moving the component from the first group to the second group.

2. The system of claim 1, wherein:
the monolithic application uses a layered architecture comprising a plurality of layers; and
the first portion of the monolithic application corresponds to a layer of the plurality of layers.

3. The system of claim 2, wherein the second portion of the monolithic application corresponds to a second layer of the plurality of layers.

4. The system of claim 1, wherein the splitting of the components of the first portion into the groups is based on a communication count between each pair of the components of the first portion.

5. The system of claim 4, wherein the operations further comprise determining the communication counts between each of the pairs of the components of the first portion based on log files.

6. The system of claim 5, wherein the splitting of the components of the first portion into the groups comprises:
generating a communication count matrix that has width and height equal to a count of the components of the first portion, each cell of the communication count matrix located at an intersection of a column and a row, each cell having a value based on the count of communications between a first component assigned to the column of the cell and a second component assigned to the row of the cell;
generating an affinity matrix based on the communication count matrix; and
applying a clustering algorithm to the affinity matrix to split the components into a predetermined number of groups.

7. The system of claim 6, wherein the generating of the affinity matrix comprises:
determining a Laplacian matrix from the communication count matrix;
determining eigenvectors of the Laplacian matrix; and
generating the affinity matrix from the eigenvectors.

8. The system of claim 1, wherein the assigning of the components of the second portion to the groups based on the communication counts comprises maximizing a total internal communication count within the groups and minimizing a total external communication count among the groups.

9. The system of claim 1, wherein the receiving of the user instruction to move the component from the first group to the second group comprises detecting that a representation of the component has been dragged from a first area of the user interface that represents the first group to a second area of the user interface that represents the second group.

10. A non-transitory computer-readable medium that stores instructions that, when executed by one or more processors, cause the one or more processors to perform operations comprising:
splitting components of a first portion of a monolithic application into groups;
determining a communication count for each of the components of the first portion with each of a plurality of components of a second portion of the monolithic application;
assigning the components of the second portion to the groups based on the communication counts;
causing presentation of a user interface that includes information about at least one of the groups;
receiving, via the user interface, a user instruction to move a component from a first group to a second group; and
in response to the user instruction, moving the component from the first group to the second group.

11. The non-transitory computer-readable medium of claim 10, wherein the splitting of the components of the first portion into the groups is based on a communication count between each pair of the components of the first portion.

12. The non-transitory computer-readable medium of claim 11, wherein the operations further comprise determining the communication counts between each of the pairs of the components of the first portion based on log files.

13. The non-transitory computer-readable medium of claim 11, wherein the splitting of the components of the first portion into the groups comprises:
generating a communication count matrix that has width and height equal to a count of the components of the first portion, each cell of the communication count matrix located at an intersection of a column and a row, each cell having a value based on the communication count between a first component assigned to the column of the cell and a second component assigned to the row of the cell;
generating an affinity matrix based on the communication count matrix; and
applying a clustering algorithm to the affinity matrix to split the components into a predetermined number of groups.

14. The non-transitory computer-readable medium of claim 13, wherein the generating of the affinity matrix comprises:
determining a Laplacian matrix from the communication count matrix;
determining eigenvectors of the Laplacian matrix; and
generating the affinity matrix from the eigenvectors.

15. The non-transitory computer-readable medium of claim 10, wherein the assigning of the components of the second portion to the groups based on the communication counts comprises maximizing a total internal communication count within the groups and minimizing a total external communication count among the groups.

16. The non-transitory computer-readable medium of claim 10, wherein the receiving of the user instruction to move the component from the first group to the second group comprises detecting that a representation of the component has been dragged from a first area of the user interface that represents the first group to a second area of the user interface that represents the second group.

17. A method comprising:
splitting, by one or more processors, components of a first portion of a monolithic application into groups;
determining a communication count for each of the components of the first portion with each of a plurality of components of a second portion of the monolithic application;
assigning the components of the second portion to the groups based on the communication counts;
causing presentation of a user interface that includes information about at least one of the groups;
receiving, via the user interface, a user instruction to move a component from a first group to a second group; and
in response to the user instruction, moving the component from the first group to the second group.

18. The method of claim 17, wherein the splitting of the components of the first portion into the groups is based on a communication count between each pair of the components of the first portion.

19. The method of claim 18, further comprising determining the communication counts between each of the pairs of the components of the first portion based on log files.

20. The method of claim 19, wherein the splitting of the components of the first portion into the groups comprises:
generating a communication count matrix that has width and height equal to a count of the components of the first portion, each cell of the communication count matrix located at an intersection of a column and a row, each cell having a value based on the communication count between a first component assigned to the column of the cell and a second component assigned to the row of the cell;
generating an affinity matrix based on the communication count matrix; and
applying a clustering algorithm to the affinity matrix to split the components into a predetermined number of groups.
